(19) United States
(12) Patent Application Publication
(10) Pub. No.: US 2003/0235461 A1
(43) Pub. Date: Dec. 25, 2003

(54) Mopstick inserting rod

(76) Inventor: Hsing-Yuan Hsu, Taichung (TW)

Correspondence Address: HSING-YUAN HSU, 235 Chung - Ho, Box 8-24, Taipei, TW

(21) Appl. No.: 10/174,830

(22) Filed: Jun. 20, 2002

(51) Int. Cl. F16G 11/00

(52) U.S. Cl. 403/299

(57) ABSTRACT

A mopstick inserting rod comprises a plurality of inserting tubes, a tightening head, and a tightening cover. The plurality of inserting tubes each has an inner reduced end which is used to be inserted into a front end of another inserting tube. The tightening head is punched to the inner reduced end of the inserting tube. The tightening cover resists against the stop edge of the tightening head. An outer surface of the tightening cover is tightly engaged to an inner surface of the inserting tube. The inner thread section is exactly engaged to the outer thread section of the tightening head. Therefore, the plurality of inserting tubes can be connected one by one so as to extend the length of the mopstick inserting rod, and the plurality of inserting tubes of the mopstick inserting rod can be detached from transferring and storage.

### FIELD OF THE INVENTION

The present invention relates to components of mops, and particularly to a mopstick inserting rod which is formed by a plurality of inserting tubes. The plurality of inserting tubes can be connected one by one so as to extend the length of the mopstick inserting rod, and the plurality of inserting tubes of the mopstick inserting rod can be detached from transfer and storage.

### BACKGROUND OF THE INVENTION

With reference to FIG. 1, the prior art inserting tubes are illustrated. A plurality of inserting tubes 5 are connected by one end of an inserting tube 5 being connected to one end of another inserting tube 5. A front end of each inserting tube 5 has a stud 6 with a thread section 61 and the distal end thereof has a connecting seat 7 with a threaded hole 71. Thereby, the thread section 61 of the connecting stud 6 of one inserting tube 5 is exactly inserted into the threaded hole 71 of the connecting seat 7 of another inserting tube 5′ so as to extend the length of the mopstick inserting rod.

However, this connection way by connection of the thread section 61 of the stud 6 and the threaded hole 71 of the connecting seat 7 will generate a weak connection. When the mop is used for a longer time, the mopstick easily bends.

### SUMMARY OF THE INVENTION

Accordingly, the primary object of the present invention is to provide a mopstick inserting rod comprising a plurality of inserting tubes, a tightening head adhered to a front end of the inserting tube, a tightening cover embedded to the tightening head.

Each of a plurality of inserting tubes has an inner reduced end. The inner reduced end of one inserting tube is exactly inserted into a front end of another inserting tube. The tightening head is punched to the inner side of the inner reduced end of the inserting tube. The tightening cover resists against the stop edge of the tightening head. An outer surface of the tightening cover is tightly engaged to an inner surface of the inserting tube. The inner thread section is exactly engaged to the outer thread section of the tightening head. A slit is formed at a longitudinal direction of the tightening cover. The tightening cover has a buckling hole with a size capable of resisting against the tightening head. The plurality of inserting tubes can be connected one by one so as to extend the length of the mopstick inserting rod, and the plurality of inserting tubes can be detached from transferring and storage.

The various objects and advantages of the present invention will be more readil understood from the following detailed description when read in conjunction with the appended drawing.

### BRIEF DESCRIPTION OF THE DRAWINGS

FIG. 1 is a plane view of a prior art.

FIG. 2 is an exploded perspective view of the present invention.

FIG. 3A is a plane cross sectional view showing the tightening status in the present invention.

FIG. 3B is a plane cross sectional view showing the releasing status in the present invention.

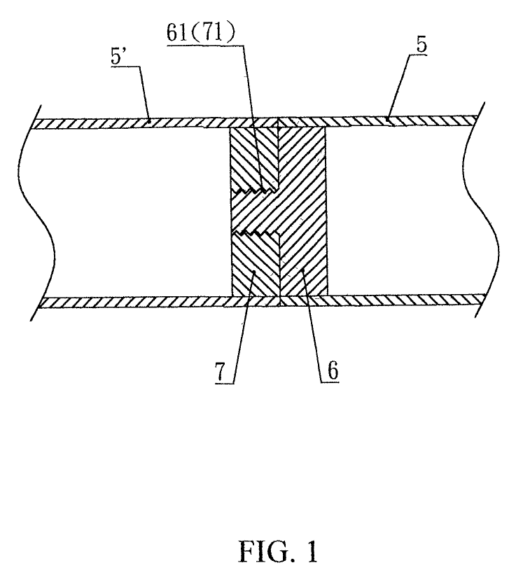

### DESCRIPTION OF THE PREFERRED EMBODIMENT OF THE PRESENT INVENTION

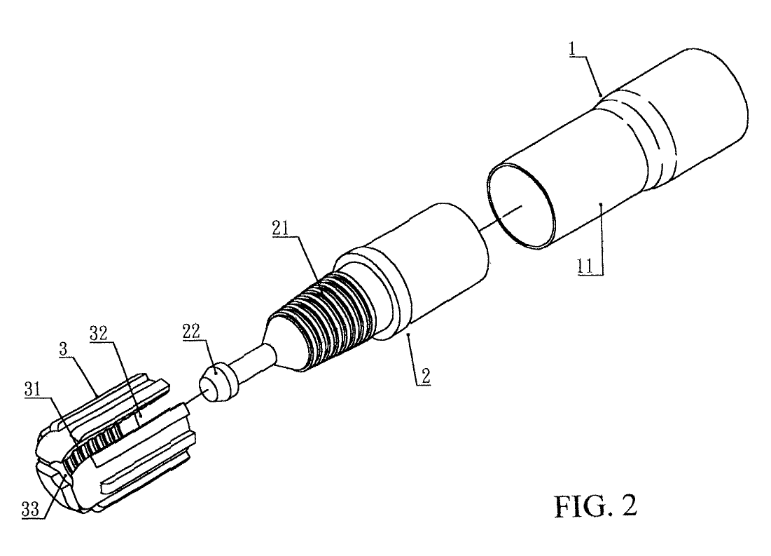

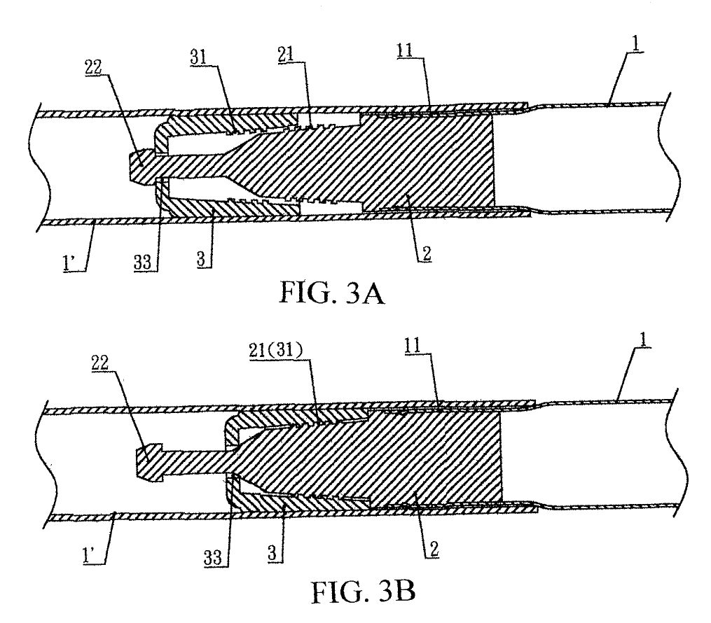

Referring to FIGS. 2 and 3, the structure of the mopstick inserting rod of the present invention is illustrated. The present invention includes a plurality of inserting tubes 1, 1′, a tightening head 2 adhered to a front end of the inserting tube 1, a tightening cover 3 embedded to the tightening head 2.

A front end of the inserting tube 1 has an inner reduced end 11 with a smaller diameter. The inner reduced end 11 exactly inserts into a front end of another inserting tube 1′. Thereby, the plurality of inserting tubes are connected with a method like the connection of the inserting tubes 1 and 1′. The whole section of the inner reduced end 11 can be inserted into another inserting tube wholly so as to enhance the engagement strength.

The tightening head 2 is punched to the inner side of the reduced end 11 of the inserting tube 1. The tightening head 2 has an outer thread section 21 which has a taper shape. A stop edge 22 extends from the distal end of the outer thread section 21. The stop edge 22 exactly resists against the tightening cover 3 so as to prevent the tightening cover 3 from releasing.

An outer diameter of the tightening cover 3 is tightly engaged to one diameter of the inserting tube 1. The inner surface of the tightening cover 3 has an inner thread section 31. The inner thread section 31 is exactly engaged to the outer thread section 21 of the tightening head 2. A slit 32 is formed at a longitudinal direction of the tightening cover 3. The slit 32 provides an expansion margin as the tightening cover 3 is engaged to the tightening head 2. The tightening head 2 has a stop edge 22. The tightening cover 3 has a buckling hole 33 with a size capable of resisting against the tightening head.

The operation of the present invention will be described herein. Referring to FIG. 3, a front end of the inserting tube I has a tightening head 2. The tightening cover 3 is stopped by the stop edge 22 of the tightening head 2 in advance. The inner reduced end 11 of the inserting tube 1 is coupled and inserted to a distal end of another inserting tube 1′. Thereby, the tightening cover 3 is within the inserting tube 1′. Then, by rotating the inserting tube 1, since the outer diameter of the tightening cover 3 is tightly engaged to the inner surface of the inserting tube 1′. Thereby, the tightening cover 3 will not rotate with the inserting tube 1. Thus, the tightening head 2 can be screwed into the inner thread section 31 of the tightening cover 3 and meanwhile, the tightening cover 3 expands outwards so that the tightening cover 3 resists against the inner wall of the inserting tube 1′. Moreover, some other inserting tube can be connected to the inserting tube 1 so as to prolong the length of the mopstick inserting rod.

When the inserting tube 1 is screwed aling a reverse direction, the tightening head 2 will release from the tightening cover 3 so that the tightening cover 3 restores to the original condition without resisting against the inner wall of the inserting tube 1′. As a result, the inserting tubes 1 and 1′ are separated from one another.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A mopstick inserting rod comprising:
a plurality of inserting tubes each having an inner reduced end; the inner reduced end of one inserting tube being exactly inserted into a front end of another inserting tube;
a tightening head punched within the inner reduced end of the inserting tube; the tightening head having an outer thread section which has a taper shape; a stop edge extending from a distal end of the outer thread section;
an tightening cover resisting against the stop edge of the tightening head; an outer surface of the tightening cover being tightly engaged to an inner surface of the inserting tube; an inner surface of the tightening cover having an inner thread section; the inner thread section being exactly engaged to the outer thread section of the tightening head a slit being formed at a longitudinal direction of the tightening cover; the tightening cover having a buckling hole with a size capable of resisting against the tightening head;
wherein the plurality of inserting tubes can be connected one by one so as to extend the length of the mopstick inserting rod, and the plurality of inserting tubes of the mopstick inserting rod can be detached from transferring and storage.
